(19) United States
(12) Patent Application Publication
(10) Pub. No.: US 2009/0002489 A1
(43) Pub. Date: Jan. 1, 2009

(54) EFFICIENT TRACKING MULTIPLE OBJECTS THROUGH OCCLUSION

(75) Inventors: Tao Yang, Xi'an (CN); Francine Chen, Menlo Park, CA (US); Donald G. Kimber, Foster City, CA (US); Xuemin Liu, Sunnyvale, CA (US); James Vaughan, Sunnyvale, CA (US)

Correspondence Address: SUGHRUE MION, PLLC, 2100 Pennsylvania Avenue, N.W., Washington, DC, 20037, US

(73) Assignee: FUJI XEROX CO., LTD., Tokyo (JP)

(21) Appl. No.: 11/771,626

(22) Filed: Jun. 29, 2007

(51) Int. Cl. H04N 7/18; G06K 9/62

(52) U.S. Cl. 348/143; 382/103; 348/E07.085

(57) ABSTRACT

Visual tracking of multiple objects in a crowded scene is critical for many applications include surveillance, video conference and human computer interaction. Complex interactions between objects result in partial or significant occlusions, making tracking a highly challenging problem. Presented is a novel efficient approach to tracking a varying number of objects through occlusion. The object tracking during occlusion is posed as a track-based segmentation problem in the joint-object space. Appearance models are used to interpret the foreground into multiple layer probabilistic masks in a Bayesian framework. The search for optimal segmentation solution is achieved by a greedy searching algorithm and integral image for real-time computing. Promising results on several challenging video surveillance sequences have been demonstrated.

### FIELD OF THE INVENTION

The present invention generally relates to tracking of objects and, more specifically, to the tracking of objects through occlusion.

### DESCRIPTION OF THE RELATED ART

Automatic video content analysis and understanding is the ultimate goal for intelligent visual surveillance systems. To this end, low-level object detection and tracking have to generate reliable data for high-level processing. The tracking module should be very efficient, in order to not to affect the speed of the whole process and, at the same time, since real world video sequences often contain complex interaction and occlusion between objects (people, vehicles, etc), it should be very robust to occlusions.

Extensive systems and methods have been proposed to handle object tracking in complex crowded scene with occlusion. Generally, those techniques can be categorized as the two approaches, which are described in Pierre Gabriel, Jacques Verly, Justus Piater, André Genon, The State of the Art in Multiple Object Tracking Under Occlusion in Video Sequences, Advanced Concepts for Intelligent Vision Systems, pp. 166-173, 200. The aforesaid two approaches include merge-split (MS) and straight-through (ST).

In the former MS approach, as soon as objects are declared to be occluding, from that point on, the original objects are encapsulated into the new group blob. When a split condition occurs, the problem is to identify the object that is splitting from the group. Appearance features such as color, texture, shape and dynamic features like motion direction, speed can be used to re-establish identity. The aforesaid appearance features are described in Haritaoglu, D. Harwood, and L. Davis. W4: real-time surveillance of people and their activities, IEEE Trans. on PAMI 22(8): pp. 809-830, August 2000 and S. McKenna, S. Jabri, Z. Duric, and H. Wechsler, Tracking Groups of People. in Computer Vision and Image Understanding, 2000. The aforesaid dynamic features are described in J. H. Piater and J. L. Crowley, Multi-modal tracking of interacting targets using Gaussian approximations, in Second IEEE International Workshop on Performance Evaluation of Tracking and Surveillance (PETS01), 2001. This approach works well with two objects merging and splitting, however, when the number of objects in a group is larger than two, the MS method frequently fails because it's difficult to tell how many objects are inside each splitting blob.

In the latter ST method, individual objects must be tracked through the occlusion without attempting to merge the objects. Beleznai et al. use a mean shift clustering procedure to search for the optimal configuration of occluding humans, see Csaba Beleznai, Bernhard Frühstück, Horst Bischof, and Walter G. Kropatsch, Model-Based Occlusion Handling for Tracking in Crowded scenes, Joint Hungarian-Austrian Conference on Image Processing and Pattern Recognition, 5th KÉPAF and 29th ÖAGM Workshop, pp. 227-234. 2005. Cucchiara et al. use an appearance model to assign each pixel to a certain track, and occlusions due to other tracks or due to background objects are discriminated, leading to a different model update mechanism, see R. Cucchiara, C. Grana, G. Tardini, Track-based and object-based occlusion for people tracking refinement in indoor surveillance, Proceedings of the ACM 2nd international workshop on Video surveillance & sensor networks (VSSN'04), pp. 81-87, New York, N.Y., USA, 2004.

Senior et al. present an approach which uses the appearance models for the tracks to estimate the separate objects' locations and their depth ordering, see A. Senior, A. Hampapur, Y-L Tian, L. Brown, S. Pankanti, R. Bolle, Appearance Models for Occlusion Handling, in Proceedings of Second International workshop on Performance Evaluation of Tracking and Surveillance systems (PETS01), December 2001. Tao et al. describe a dynamic layer approach which relies on an appearance model to deal with partial occlusion of passing vehicles as seen from above, see H. Tao, H. Sawhney, and R. Kumar. Dynamic layer representation with applications to tracking, Proceedings of IEEE Conference on Computer Vision and Pattern Recognition (CVPR00), Volume: 2, pp. 134-41 vol. 2, Hilton Head Island, S.C., USA,2000. Examples of temporal correlation, Kalman Filter and Monte Carlo approaches as well as Particle Filtering are described in T. Zhao, R. Nevatia, F. Lv, Segmentation and Tracking of Multiple Humans in Complex Situations, Proceedings of IEEE Conference on Computer Vision and Pattern Recognition (CVPR01), Volume: 2, pp. 194-201, Kauai, Hi., 2001; M. Isard and J. MacCormick, BraMBLE: a Bayesian multiple-blob tracker, IEEE Conference on Computer Vision (ICCV01), Volume: 2, pp. 34-41, 2001 and Kevin Smith, Daniel Gatica-Perez, and Jean-Marc Odobez, Using Particles to Track Varying Numbers of Interacting People, Proceedings of IEEE Conference on Computer Vision and Pattern Recognition (CVPR05), Volume: 1, pp. 962- 969, San Diego, Calif., USA, June 2005.

Despite the above advances, the existing technology is characterized by poor object tracking performance especially when there is a large amount of occlusion between two or more objects. Therefore, what is needed is a highly efficient occlusion handling scheme, which significantly improves tracking performance even when there is a large amount of occlusion between two or more objects.

### SUMMARY OF THE INVENTION

The inventive methodology is directed to methods and systems that substantially obviate one or more of the above and other problems associated with conventional techniques for object tracking.

In accordance with one aspect of the inventive concept, there is provided a method for object tracking with occlusion. The inventive method involves: generating an object model for each of a plurality of objects, wherein the generated object model comprises at least one feature of the object; obtaining an image of a group of objects; scanning each generated object model over the obtained image of a group of objects and computing a conditional probability for each object model based on the at least one feature; and selecting an object model with the maximum computed conditional probability and determining the location of the corresponding object within the group of objects. The last two steps are repeated for at least one non-selected object model. Finally, each object is tracked within the group of objects using a tracking history of the tracked object and the determined location of the tracked object within the group of objects.

In accordance with another aspect of the inventive concept, there is provided an object tracking system including at least one camera operable to acquire an image of a group of objects and a processing unit. The processing unit is configured to: generate an object model for each of a plurality of objects, wherein the generated object model comprises at least one feature of the object; scan each generated object model over the acquired image of a group of objects and compute conditional probability for each object model based on the at least one feature; select an object model with the maximum computed conditional probability and determine the location of the corresponding object within the group of objects; repeat the previous two steps for at least one non-selected object model; and track each object within the group of objects using tracking history of the tracked object and the determined location of the tracked object within the group of objects.

In accordance with yet another aspect of the inventive concept, there is provided a computer-readable medium including instructions implementing a method for object tracking with occlusion. The inventive method involves: generating an object model for each of a plurality of objects, wherein the generated object model comprises at least one feature of the object; obtaining an image of a group of objects; scanning each generated object model over the obtained image of a group of objects and computing a conditional probability for each object model based on the at least one feature; and selecting an object model with the maximum computed conditional probability and determining the location of the corresponding object within the group of objects. The last two steps are repeated for at least one non-selected object model. Finally, each object is tracked within the group of objects using a tracking history of the tracked object and the determined location of the tracked object within the group of objects.

In accordance with yet another aspect of the inventive concept, there is provided a surveillance system including at least one camera operable to acquire an image of a group of objects and a processing unit. The processing unit is configured to: generate an object model for each of a plurality of objects, wherein the generated object model comprises at least one feature of the object; scan each generated object model over the acquired image of a group of objects and compute conditional probability for each object model based on the at least one feature; select an object model with the maximum computed conditional probability and determine the location of the corresponding object within the group of objects; repeat the previous two steps for at least one non-selected object model; and track each object within the group of objects using tracking history of the tracked object and the determined location of the tracked object within the group of objects.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary processing flow in an embodiment of the inventive object tracking system.

FIG. 2 illustrates an exemplary embodiment of the inventive image processing algorithm.

FIG. 3 illustrates an exemplary embodiment of an algorithm for occlusion disambiguation.

FIG. 4 illustrates object tracking with occlusion by an embodiment of the inventive system using a video from a benchmark dataset.

FIG. 5 illustrates object tracking with occlusion by an embodiment of the inventive system using a video from another benchmark dataset.

FIG. 6 illustrates object tracking with occlusion by an embodiment of the inventive system using a video from yet another benchmark dataset.

FIG. 7 illustrates object tracking with occlusion by an embodiment of the inventive system using a video from yet another benchmark dataset.

FIG. 8 illustrates an exemplary embodiment of a computer platform upon which the inventive system may be implemented.

### DETAILED DESCRIPTION

In the following detailed description, reference will be made to the accompanying drawing(s), in which identical functional elements are designated with similar numerals. The aforementioned accompanying drawings show by way of illustration and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

An embodiment of the inventive concept is a fast and reliable approach to find the best configuration of objects during occlusion. One embodiment of the inventive methodology is a novel occlusion handling scheme, which significantly improves tracking performance even in large occlusion between two or more objects. In this scheme, the object tracking during occlusion is posed as a track-based segmentation problem in the joint-object space. Features that are estimated during tracking are used to interpret the foreground into multiple layer probabilistic masks in a Bayesian framework. A highly efficient searching method is given to determine the configuration of occluding objects in the probabilistic layers. Moreover, object probabilities in the searching process can be computed by integral image.

### Technical Details

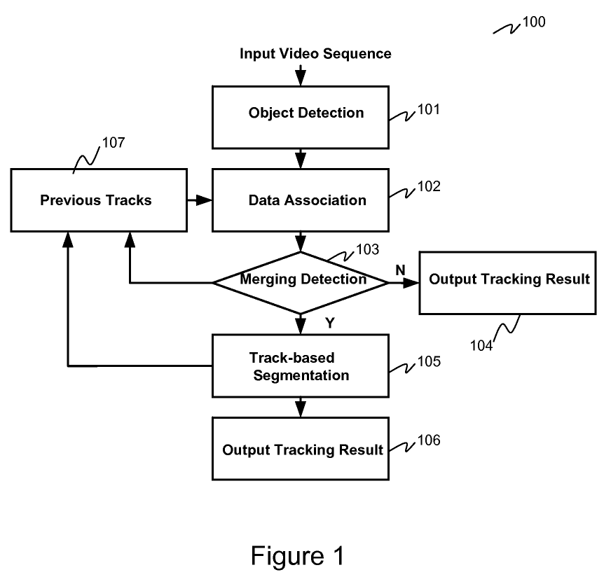

FIG. 1 illustrates an exemplary processing flow in an embodiment of the inventive object tracking system. The inventive object tracking system 100 shown in FIG. 1 includes three main parts: (1) object detection 101, (2) data association 102, and (3) track-based segmentation 105 for occlusion handling. An embodiment of the inventive system may be implemented using a plurality of modules, each module corresponding to the processing step in the sequence show in FIG. 1. In addition to object detection, data association and track-based segmentation, the object tracking sequence 100 also includes merging detection 103, tracking result output 104 and 105 and previous tracks handling 107.

The detection step 101 may implement various algorithms for background modeling and change detection. Exemplary suitable algorithms are described in Collins R et al, A system for video surveillance and monitoring: VSAM final report, Carnegie Mellon University, Technical Report: CMU-RI-TR-00-12, 2000; C. Stauffer, W. Eric L. Grimson, Learning Patterns of Activity Using Real-Time Tracking. IEEE Transactions on Pattern Analysis and Machine Intelligence, Volume 22, Issue 8, pages 747-757, August 2000; and TaoYang, Stan. Z. Li, QuanPan, JingLi, Real-time Multiple Object Tracking with Occlusion Handling in Dynamic Scenes, IEEE Computer Society Conference on Computer Vision and Pattern Recognition Conference (CVPR05), San Diego, USA, 20-25, Jun. 2005. In one embodiment, a Gaussian Mixture Model described in C. Stauffer et al., mentioned above, is utilized to estimate the reference background, and use a feature level comparison technique to obtain foreground pixels.

In the data association step 102, a Boolean correspondence matrix C between the previous tracks T and current measured bounding box M is exploited to represent all possible conditions of object's interaction, such as continuation, appearing, disappearing, merging and splitting. The association is established if the similarity between track Tᵢ and the measure Mⱼ is larger than a threshold. Spatial or appearance features can be used to compute the similarity, and in our system, it is computed as overlapping rate between two bounding boxes (1).

$$O ( {T}_{i} , {M}_{j} ) = \frac{2 \cdot {S}_{{T}_{i} ⋂ {M}_{j}}}{{S}_{{T}_{i}} + {S}_{{M}_{j}}} , i = 1 , … m , j = 1 , … , n \qquad ( 1 )$$

where S_{T}_{ᵢ}_{∩M}_{ⱼ}, S_{T}_{ᵢ} and S_{M}_{ⱼ} represent the area of the overlapped region, track Tᵢ and the measure Mⱼ respectively. Compared to methods based on the distance between bounding box described in Cucchiara et al. and A. Senior et al., mentioned above, Equation (1) fuses the spatial distance and size difference in one formula. The element C_{i,j} is set to 1 if there is an association between the corresponding regions and 0 otherwise. Using the value of the correspondence matrix C to classify object's interactions has been discussed in many previous works, for example in R. Cucchiara et al., A. Senior et al. and TaoYang et al., mentioned hereinabove, and in Yan Huang, Irfan A. Essa, Tracking Multiple Objects through Occlusions, IEEE Computer Society Conference on Computer Vision and Pattern Recognition Conference (CVPR05), Vol 2, pp. 1051-1058,San Diego, USA, 20-25, Jun. 2005. Five different cases can arise: (1) continuation: the corresponding column and row have only one non-zero element; (2) appearing: the corresponding column has all zero elements; (3) disappearing: The corresponding row has all zero elements; (4) merging: the corresponding column has more than one non-zero elements; and (5) splitting: the corresponding row has more than one non-zero elements.

### Track-Based Segmentation for Occlusion Handling

In the track-based segmentation step 105, the merging detection result is used to determine which objects are involved in occlusion, and the information estimated from the tracking history of each object is used to build the probabilistic mask layer. In an embodiment of the inventive system, the color distribution q is selected for this purpose.

Let {xₖ}_{k=1, . . . , nh} denote pixel locations of the target candidate centered y. Represent the color distribution qᵤ^{t} by a discrete m-bin color histogram at time t. Let b(xₖ) denote the color bin of the color at xₖ, then the probability q of color u is:

$${q}_{u}^{t} = \frac{1}{d} {\sum }_{i = 1}^{n} k ( {‖ \frac{{x}_{k} - y}{h} ‖}^{2} ) δ ( b ( {x}_{k} ) - u ) \qquad ( 2 )$$

where d is the normalization constant (3), k:[0, ∞)→R is a convex and monotonic decreasing function which assigns a smaller weight to the locations that are farther from the center of the target.

$$d = [ {\sum }_{i = 1}^{n} k ( {‖ ( \frac{{x}_{k} - y}{h} ) ‖}^{2} ) ] \qquad ( 3 )$$

In many cases, when an object first appears in one camera, only part of the body can be seen. In addition, due to the illumination changes in different image position, the object color may be different. Thus it's not suitable to pick one frame segmentation result to build the object template color model. In an embodiment of the inventive system, the color distribution qᵤ^{t} is updated dynamically before occlusion, and then the color distribution qᵤ^{t} of track Tᵢ at time t is given by (4).

$${q}_{u}^{t} = ( 1 - \frac{1}{t} ) {q}_{u}^{t - 1} + \frac{1}{t} {q}_{u}^{t} \qquad ( 4 )$$

Suppose occlusion between the tracked objects is detected, and the data association module determines the group O_{g}, g=1, . . . , N contains N objects. Then the search for most probable configuration O_{g}* becomes a maximum a posteriori estimation problem:

$${O}_{g}^{*} = arg {max}_{{O}_{g}} P ( {O}_{g} \vert G ) \qquad ( 5 )$$

To solve this problem, Beleznai et al., mentioned hereinabove, generate a sample set of points within the occluded object window, and carry out the mean shift procedure to find the configurations of occluded objects. All the configurations are evaluated and the best configuration is taken. Their method works well for two object occlusion, however, thousands of configurations are necessary when more than two objects form an occluded group, which is time consuming.

Because inter-object occlusion might be present, each object Oᵢ is NOT conditionally independent of every other object Oⱼ for i≠j. Using conditional probability, P(O_{g}|G) can be written as:

$$\begin{matrix}P ( {O}_{g} \vert G ) = p ( {O}_{1} , … , {O}_{N} \vert G ) \\ = p ( {O}_{1} \vert G ) p ( {O}_{2} , … , {O}_{N} \vert G , {O}_{1} ) \\ = p ( {O}_{1} \vert G ) p ( {O}_{2} \vert G , {O}_{1} ) p ( {O}_{3} , … , {O}_{N} \vert G , {O}_{1} , {O}_{2} ) \\ = p ( {O}_{1} \vert G ) {\prod }_{i = 2}^{N} p ( {O}_{i} \vert G , {O}_{1} , … , {O}_{i - 1} )\end{matrix} \qquad ( 6 )$$

and equation (5) can be rewritten as follows (7).

$${O}_{g}^{*} = arg {max}_{{O}_{g}} p ( {O}_{1} \vert G ) {\sum }_{i = 2}^{N} p ( {O}_{i} \vert G , {O}_{1} , … , {O}_{i - 1} ) \qquad ( 7 )$$

Although dynamic programming is exhaustive and is guaranteed to find the solution of (7), it's quite time consuming and not suitable for tracking. An embodiment of the inventive system exploits the greedy algorithm to find the best configuration in the stages. A greedy algorithm is an algorithm that making the locally optimum choice at each stage with the hope of finding the global optimum.

Suppose we have found the best configuration O_{g}*={O₁*, . . . , O_{N}*}, we can order the N objects into N layers according to their visible ratios, computed as the fraction of the object model visible in the best configuration.

Usually the object with higher visible ratio in the group will have a higher observation probability. Thus we can directly find the object O₁* in the first stage by (8)

$${O}_{1}^{*} = arg {max}_{{O}_{i}} P ( {O}_{i} \vert G ) \qquad ( 8 )$$

where P(Oᵢ|G) is the maximum a posteriori of object Oᵢ searching over the foreground group G.

After that, we can find the position of objects in other stages by searching for the maximum probability in each stage:

$${O}_{m}^{*} = arg {max}_{{O}_{i}} P ( {O}_{i} \vert G , {O}_{1}^{*} , … , {O}_{m - 1}^{*} ) \qquad ( 9 )$$

where i=1, . . . N, Oᵢ∉{Oⱼ*}, j=1, . . . , m−1.

To compute the probability P(Oᵢ|G, O₁*, . . . , Oₘ₋₁*) at a stage m, we scan each object model over the entire group G, and use equation (10) to estimate the probability:

P(Oᵢ|G,O₁*, . . . , Oₘ₋₁*)=max(P(Oᵢ|F_{xc})), xc∈G (10)

where F_{xc} is the covered foreground image inside the object's mask and centered at pixel xc, and P(Oᵢ|F_{xc}) is computed as the average probability over the pixels (11).

$$P ( {O}_{i} \vert {F}_{xc} ) = \frac{1}{w \cdot h} {\sum }_{{x}_{k} ∈ {F}_{xc}} P ( {O}_{i} \vert I ( {x}_{k} ) \qquad ( 11 )$$

where I(xₖ) is the intensity value of the pixel located at Xₖ, w and h is the width and height of object Oᵢ. The conditional probability P(Oᵢ|I(xₖ)) is computed using Bayes' theorem as:

$$P ( {O}_{i} \vert I ( {x}_{k} ) ) = \frac{P ( I ( {x}_{k} ) \vert {O}_{i} ) P ( {O}_{i} )}{{\sum }_{s = 1}^{N} P ( I ( {x}_{k} ) \vert {O}_{s} ) P ( {O}_{s} )} \qquad ( 12 )$$

where Oₛ∉{Oⱼ*}, j=1, . . . , m−1.

The described method of determining P(Oᵢ|F_{xc}) is one exemplary method; however, other methods with different assumptions can be used. For example, rather than computing the average probability over the pixels, if we assume conditional independence of the pixels in Oᵢ, then we can compute P(Oᵢ|F_{xc}) in equation (10) as:

$$\begin{matrix}P ( {O}_{i} \vert {F}_{xc} ) = \frac{P ( {F}_{xc} \vert {O}_{i} ) P ( {O}_{i} )}{{\sum }_{s = 1}^{N} P ( {F}_{xc} \vert {O}_{s} ) P ( {O}_{s} )} \\ = \frac{{\prod }_{k} P ( I ( {x}_{k} ) \vert {O}_{i} ) P ( {O}_{i} )}{{\sum }_{s = 1}^{N} {\prod }_{k} P ( I ( {x}_{k} ) \vert {O}_{s} ) P ( {O}_{s} )}\end{matrix} \qquad ( 12 a )$$

In practice P(I(xₖ)|Oᵢ) is estimated by color histogram (4) of object Oᵢ, P(Oᵢ) is the comparative size of objects before occlusion, and the sum of pixel probability in (11) is computed by a two-dimensional integral image in real-time, as described in P. Viola and M. Jones, Rapid object detection using a boosted cascade of simple features, IEEE Computer Society Conference on Computer Vision and Pattern Recognition Conference (CVPR01), Vol 1, pp. 511-518, Kauai, Hi., 2001.

Because the probability of individual object hypotheses are not independent, pixels covered by selected objects in previous stages should be removed from the current search space. Considering the non-rigid contour of the object, the rectangular model that was used is not precise enough. Thus, instead of removing covered pixels, we punish their probabilities according to their distance to the center of nearest objects selected in previous stages. This punishment is based on the assumption that pixels near the boundary have higher possibilities to be occluded, and usually this assumption is valid for many surveillance scenarios. Thus the equation (12) is rewritten as (13) for objects in stage i, where i>1.

$$P ( {O}_{i} \vert I ( {x}_{k} ) ) == \{ \begin{matrix}\frac{P ( I ( {x}_{k} ) \vert {O}_{i} ) P ( {O}_{i} )}{{\sum }_{j = 1}^{N} P ( I ( {x}_{k} ) \vert {O}_{j} ) P ( {O}_{i} )} & {x}_{i} ∈ {X}_{g}^{-} \\ \frac{P ( I ( {x}_{k} ) \vert {O}_{i} ) P ( {O}_{i} )}{{\sum }_{j = 1}^{N} P ( I ( {x}_{k} ) \vert {O}_{j} ) P ( {O}_{i} )} ϕ ( ‖ \frac{{x}_{i} - y}{h} ‖ ) & {x}_{i} ∈ {X}_{g}^{+}\end{matrix} \qquad ( 13 )$$

Where X_{g}⁺ is the set of pixel covered by objects in previous stages, X_{g}⁻ represent the set of uncovered pixel, φ:[0, ∞)→R is a concave and monotonic increasing function which assigns a smaller weight to the locations that are near the center y of selected target in previous stages.

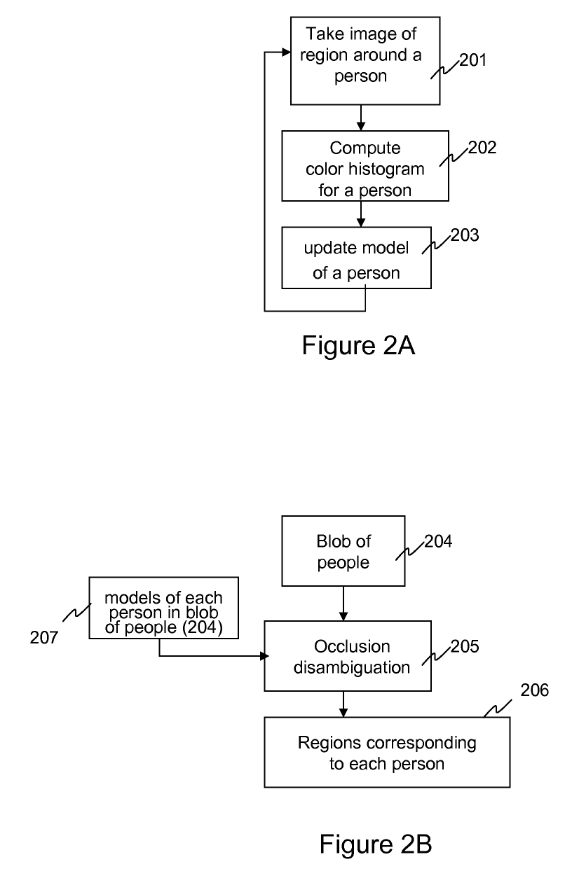

FIG. 2A illustrates an exemplary embodiment of the inventive algorithm for creating a model of a person. A region containing one person is identified in step 201. In one embodiment, in step 202, based on the region identified in step 201, a color histogram of a person is created. This color histogram is utilized at step 203 to obtain or update the person's model. The sequence of steps 201 through 203 is repeated continuously in order to keep the person's model updated. The aforesaid resulting model of a person is based on various visual characteristics of person's image. In addition to the color histogram generated in exemplary step 202, the person's model may be built based on other image features of a person, as well as person's texture characteristics. In one embodiment, the person's model approximates the shape of a person as a single rectangle. In another embodiment, the shape is approximated as a larger rectangle with a smaller rectangle on top, representing a person's head. In the case of objects, the model may use any appropriate approximation of an object's shape.

FIG. 2B illustrates an inventive algorithm for occlusion disambiguation. Specifically, in step 204, an image of a blob of persons is obtained from the step 103 of the algorithm shown in FIG. 1. Occlusion disambiguation is performed at step 205 using the aforesaid image of the blob and the model 207 built in steps 201-203 of FIG. 2A. As the result of the occlusion disambiguation step 205, regions corresponding to each person are determined in step 206. The locations of these regions are tracked by the inventive tracker.

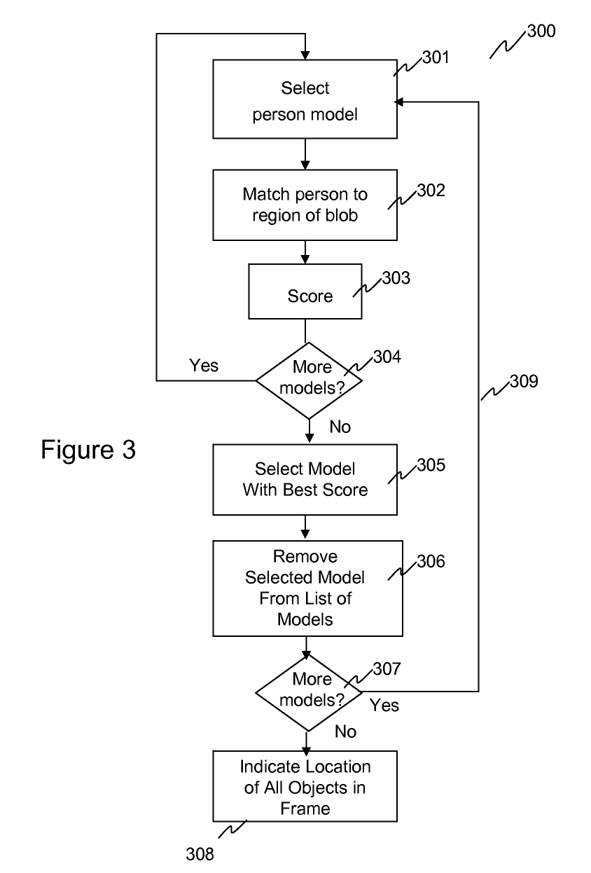

FIG. 3 illustrates an exemplary embodiment of an algorithm for occlusion disambiguation. Specifically, at step 301, a person's model is selected from the set of models corresponding to the persons in the blob as identified in step 103. Each selected model is matched to a region in the blob in step 302. Each match is scored in step 303 as described hereinabove. The steps 301-303 are repeated for all models, see step 304. The model with the best score is selected in step 305. Pursuant to the greedy nature of the algorithm utilized in the occlusion disambiguation, the model selected in step 305 is removed from the list of models. If in step 307 it is determined that more models remain, the algorithm processes those remaining models in accordance with loop 309. Otherwise, in step 308, locations of all objects in a frame are indicated.

It should be noted that exemplary embodiments of the inventive system are illustrated in FIGS. 2A, 2B and 3 using persons as objects being tracked. However, it will be apparent to persons of skill in the art, that any types of objects can be used apart from persons.

### Embodiment of Object Tracking System

An exemplary embodiment of inventive real-time object tracking system was developed in the C++ programming language. At a resolution of 320×240 pixels, it ran at 15 frames per second on average on a 3.0 GHz standard PC. Up to now, it has been tested over on several sequences of Benchmark datasets in indoor and outdoor environments, including PETS2000, PETS2006 and IBM performance evaluation dataset In this section, its performance for object tracking on the above datasets is presented.

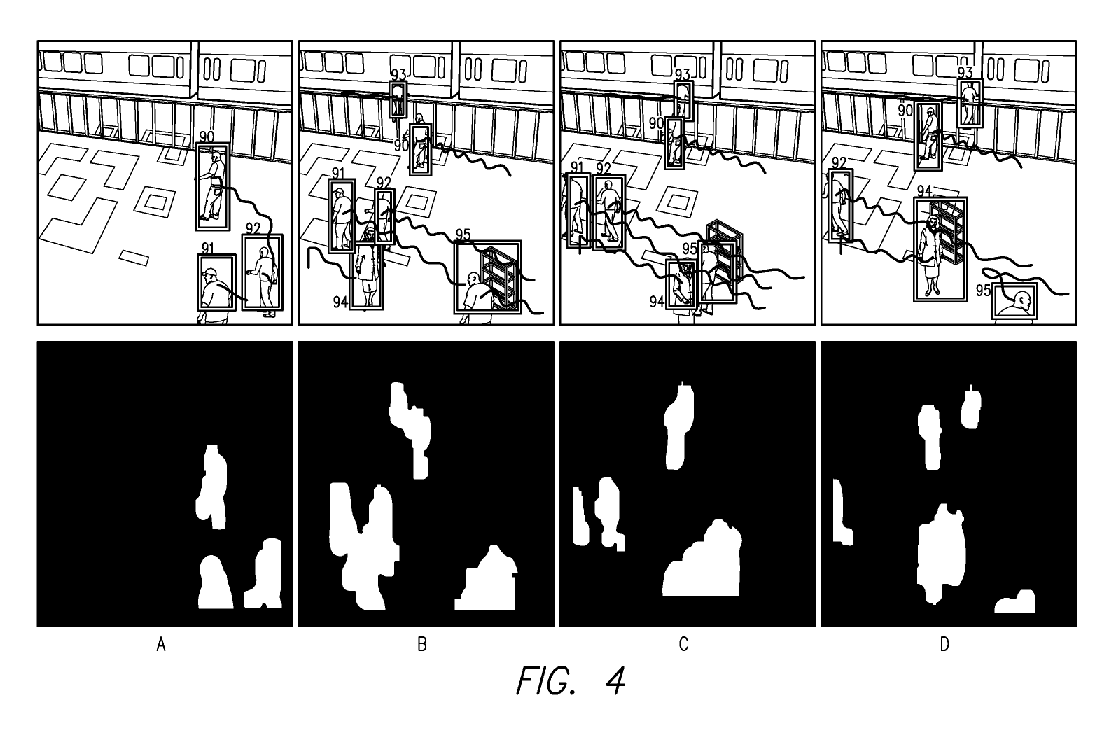

The PETS2006 Benchmark Dataset contains a sequence taken from a moderately busy railway station with people walking in isolation or as part of large groups, as shown in FIG. 4. The scenarios are captured by four cameras from different view points. We use the sequence from camera 3 in this example. The first row shows the input image and tracking result, and the second row contains the foreground image. Before occlusion (FIG. 4.a) the color feature of each person is dynamically updated. Note that three objects form an occluded group in FIG. 4.c, moreover, similar color exists among objects 91, 92 and 94. Merging and splitting (MS) based methods may fail at this condition. However, by computing the conditional probability of each pixel in the group using equations (12) and (13), the probabilities of discriminate color features of each object are enhanced and each object is segmented correctly (FIG. 4.c). Note that a tracking error appears in FIG. 4.d of between objects 94 and 95 due to a simple nearest neighbor data association.

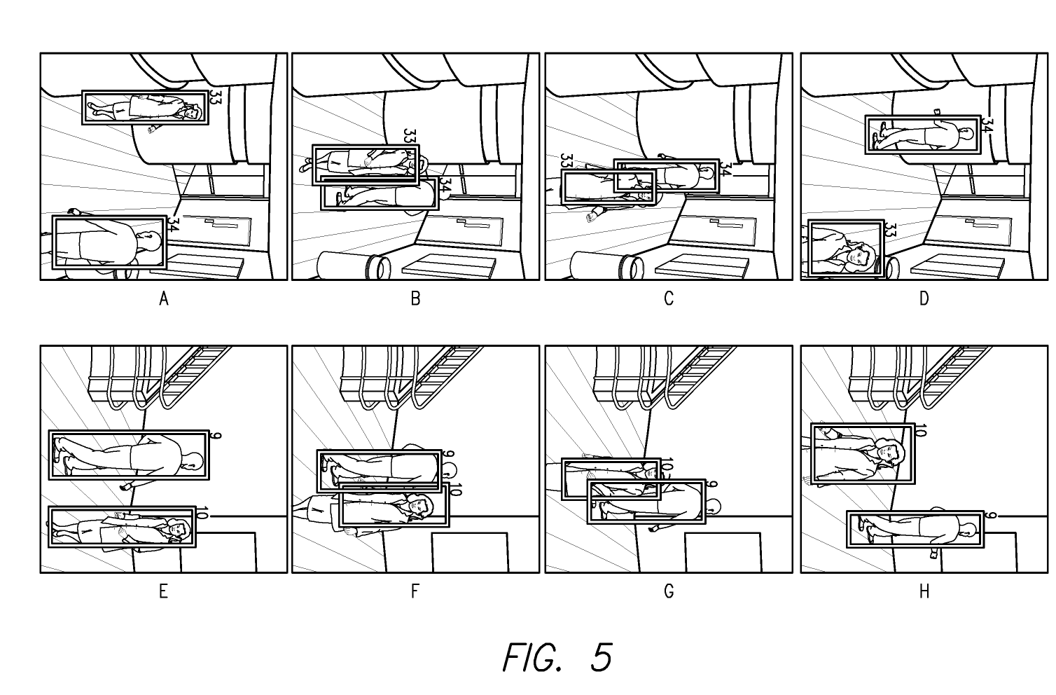

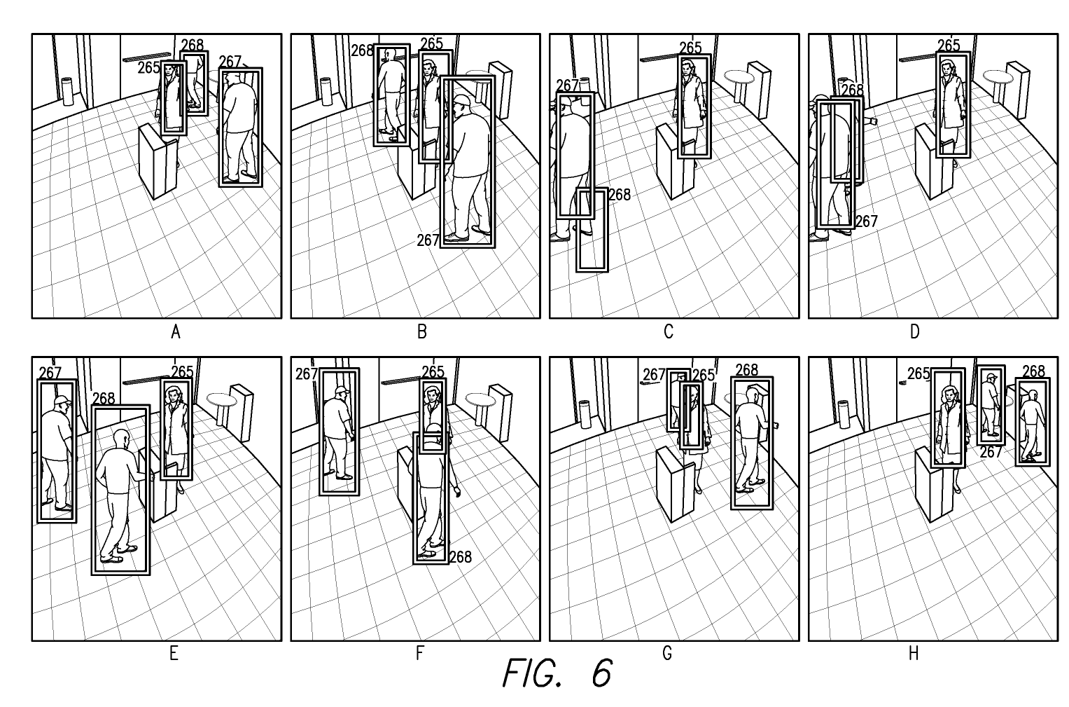

The sequences of FIG. 5 and FIG. 6 are taken from the IBM performance evaluation dataset. In FIG. 5, two persons walk across each other in different indoor business scene with complex backgrounds. The tracking works very well during partial occlusion (FIG. 5.b, 5.c, 5.f, 5.g) in both scenes. FIG. 6 shows tracking result of three persons inside a room. In this sequence, one person (FIG. 6, object 256) is standing while the other two circle around her. Note that in FIG. 6.c, object 268 is heavily occluded by object 267, and a tracking error appears on object 268 in this frame. In this condition, many local optimum searching methods like mean-shift may fail. Since our approach is searching for the best configuration over the entire group in every frame during occlusion, once an object reappears, the system will recover from a tracking error immediately (FIG. 6.d).

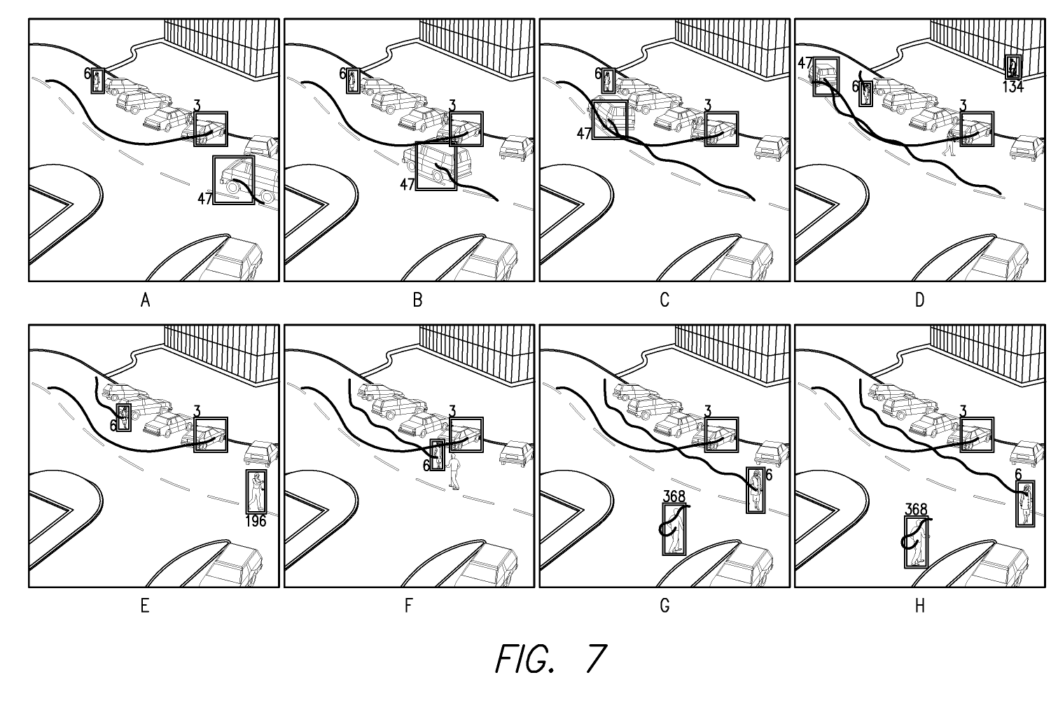

The PETS2000 Benchmark dataset was used to test the performance of an embodiment of the inventive system in outdoor scene. FIG. 7 shows tracks of different people and a vehicle in one sequence. It should be noted that the inventive approach accurately handles various interactions between the vehicle and person (FIG. 7.c, 7.f).

As can be seen from the experimental results above, the inventive tracker is capable of tracking complex interactions of multiple objects under different conditions, such as partial or complete occlusion. Object segmentation during occlusion is achieved by a greedy searching method based on the visible ratio of each object in the group, and integral image is used to compute the image probabilities in real-time.

### Exemplary Computer Platform

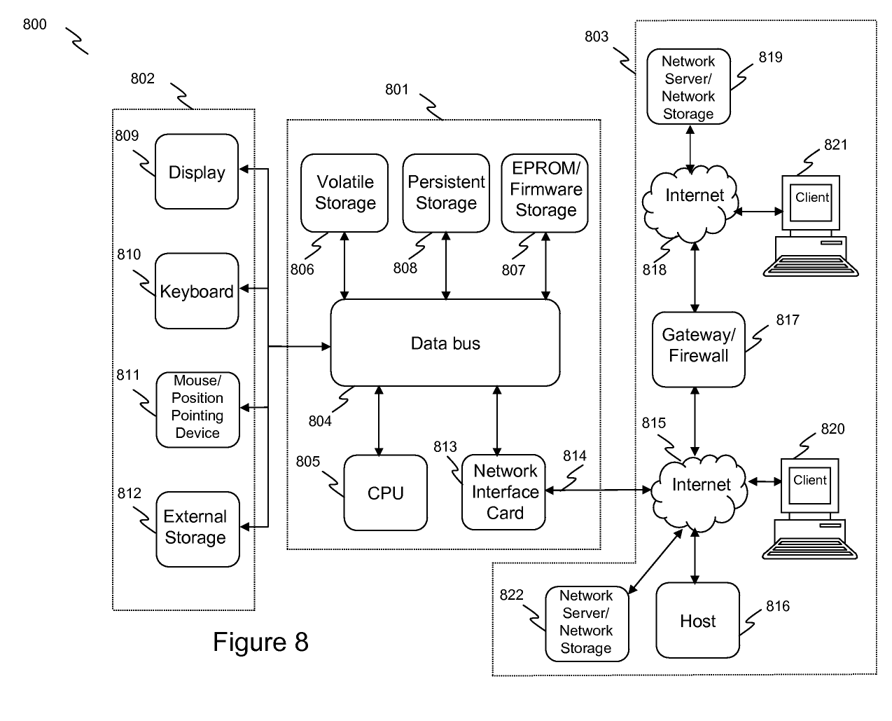

FIG. 8 shows a block diagram that illustrates an embodiment of a computer/server system 800 upon which an embodiment of the inventive methodology may be implemented. The system 800 includes a computer/server platform 801, peripheral devices 802 and network resources 803.

The computer platform 801 may include a data bus 804 or other communication mechanism for communicating information across and among various parts of the computer platform 801, and a processor 805 coupled with bus 801 for processing information and performing other computational and control tasks. Computer platform 801 also includes a volatile storage 806, such as a random access memory (RAM) or other dynamic storage device, coupled to bus 804 for storing various information as well as instructions to be executed by processor 805. The volatile storage 806 also may be used for storing temporary variables or other intermediate information during execution of instructions by processor 805. Computer platform 801 may further include a read only memory (ROM or EPROM) 807 or other static storage device coupled to bus 804 for storing static information and instructions for processor 805, such as basic input-output system (BIOS), as well as various system configuration parameters. A persistent storage device 808, such as a magnetic disk, optical disk, or solid-state flash memory device is provided and coupled to bus 801 for storing information and instructions.

Computer platform 801 may be coupled via bus 804 to a display 809, such as a cathode ray tube (CRT), plasma display, or a liquid crystal display (LCD), for displaying information to a system administrator or user of the computer platform 801. An input device 810, including alphanumeric and other keys, is coupled to bus 801 for communicating information and command selections to processor 805. Another type of user input device is cursor control device 811, such as a mouse, a trackball, or cursor direction keys for communicating direction information and command selections to processor 804 and for controlling cursor movement on display 809. This input device typically has two degrees of freedom in two axes, a first axis (e.g., x) and a second axis (e.g., y), that allows the device to specify positions in a plane.

An external storage device 812 may be connected to the computer platform 801 via bus 804 to provide an extra or removable storage capacity for the computer platform 801. In an embodiment of the computer system 800, the external removable storage device 812 may be used to facilitate exchange of data with other computer systems.

The invention is related to the use of computer system 800 for implementing the techniques described herein. In an embodiment, the inventive system may reside on a machine such as computer platform 801. According to one embodiment of the invention, the techniques described herein are performed by computer system 800 in response to processor 805 executing one or more sequences of one or more instructions contained in the volatile memory 806. Such instructions may be read into volatile memory 806 from another computer-readable medium, such as persistent storage device 808. Execution of the sequences of instructions contained in the volatile memory 806 causes processor 805 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 805 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 808. Volatile media includes dynamic memory, such as volatile storage 806. Transmission media includes coaxial cables, copper wire and fiber optics, including the wires that comprise data bus 804. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 805 for execution. For example, the instructions may initially be carried on a magnetic disk from a remote computer. Alternatively, a remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on the data bus 804. The bus 804 carries the data to the volatile storage 806, from which processor 805 retrieves and executes the instructions. The instructions received by the volatile memory 806 may optionally be stored on persistent storage device 808 either before or after execution by processor 805. The instructions may also be downloaded into the computer platform 801 via Internet using a variety of network data communication protocols well known in the art.

The computer platform 801 also includes a communication interface, such as network interface card 813 coupled to the data bus 804. Communication interface 813 provides a two-way data communication coupling to a network link 814 that is connected to a local network 815. For example, communication interface 813 may be an integrated services digital network (ISDN) card or a modem to provide a data communication connection to a corresponding type of telephone line. As another example, communication interface 813 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 813 sends and receives electrical, electromagnetic or optical signals that carry digital data streams representing various types of information.

Network link 813 typically provides data communication through one or more networks to other network resources. For example, network link 814 may provide a connection through local network 815 to a host computer 816, or a network storage/server 817. Additionally or alternatively, the network link 813 may connect through gateway/firewall 817 to the wide-area or global network 818, such as an Internet. Thus, the computer platform 801 can access network resources located anywhere on the Internet 818, such as a remote network storage/server 819. On the other hand, the computer platform 801 may also be accessed by clients located anywhere on the local area network 815 and/or the Internet 818. The network clients 820 and 821 may themselves be implemented based on the computer platform similar to the platform 801.

Local network 815 and the Internet 818 both use electrical, electromagnetic or optical signals that carry digital data streams. The signals through the various networks and the signals on network link 814 and through communication interface 813, which carry the digital data to and from computer platform 801, are exemplary forms of carrier waves transporting the information.

Computer platform 801 can send messages and receive data, including program code, through the variety of network(s) including Internet 818 and LAN 815, network link 814 and communication interface 813. In the Internet example, when the system 801 acts as a network server, it might transmit a requested code or data for an application program running on client(s) 820 and/or 821 through Internet 818, gateway/firewall 817, local area network 815 and communication interface 813. Similarly, it may receive code from other network resources.

The received code may be executed by processor 805 as it is received, and/or stored in persistent or volatile storage devices 808 and 806, respectively, or other non-volatile storage for later execution. In this manner, computer system 801 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in a computerized object tracking system. It is intended that the specification and examples be considered as exemplary only, with a true scope and spirit of the invention being indicated by the following claims.

What is claimed is:

1. A method for object tracking with occlusion, the method comprising:
a. Generating an object model for each of a plurality of objects, wherein the generated object model comprises at least one feature of the object;
b. Obtaining an image of a group of objects;
c. Scanning each generated object model over the obtained image of a group of objects and computing a conditional probability for each object model based on the at least one feature;
d. Selecting an object model with the maximum computed conditional probability and determining the location of the corresponding object within the group of objects;
e. Repeating steps c. and d. for at least one non-selected object model; and
f. Tracking each object within the group of objects using a tracking history of the tracked object and the determined location of the tracked object within the group of objects.

2. The method of claim 1, wherein the at least one feature is computed using an integral image of the object.

3. The method of claim 1, wherein pixel probabilities of a first object are punished for being farther from a center of a target object.

4. The method of claim 1, wherein pixel probabilities of an occluded object are punished for being close to a center of targets or objects selected in an earlier iteration.

5. The method of claim 1, wherein a maximum conditional probability is computed as an average probability over probabilities of pixels inside an object mask.

6. The method of claim 1, wherein a maximum conditional probability is computed as a joint probability over pixels inside an object mask.

7. The method of claim 1, wherein the at least one feature comprises a color distribution of the object represented by a color histogram.

8. The method of claim 1, wherein the at least one feature comprises a texture of the object.

9. The method of claim 1, further comprising dynamically updating the at least one feature of the object.

10. The method of claim 1, wherein the object is a person.

11. An object tracking system comprising at least one camera operable to acquire an image of a group of objects and a processing unit operable to:
a. Generate an object model for each of a plurality of objects, wherein the generated object model comprises at least one feature of the object;
b. Scan each generated object model over the acquired image of a group of objects and compute conditional probability for each object model based on the at least one feature;
c. Select an object model with the maximum computed conditional probability and determine the location of the corresponding object within the group of objects;
d. Repeat steps c. and d. for at least one non-selected object model; and
e. Track each object within the group of objects using tracking history of the tracked object and the determined location of the tracked object within the group of objects.

12. The object tracking system of claim 11, wherein the at least one feature comprises an integral image of the object.

13. The object tracking system of claim 11, wherein the at least one feature comprises a color distribution of the object represented by a color histogram.

14. The object tracking system of claim 11, wherein the at least one feature comprises a texture of the object.

15. The object tracking system of claim 11, further comprising dynamically updating the at least one feature of the object.

16. The object tracking system of claim 11, wherein the object is a person.

17. A computer readable medium embodying a set of computer instructions implementing a method for object tracking with occlusion, the method comprising:
a. Generating an object model for each of a plurality of objects, wherein the generated object model comprises at least one feature of the object;
b. Obtaining an image of a group of objects;
c. Scanning each generated object model over the obtained image of a group of objects and computing conditional probability for each object model based on the at least one feature;
d. Selecting an object model with the maximum computed conditional probability and determining the location of the corresponding object within the group of objects;
e. Repeating steps c. and d. for at least one non-selected object model; and
f. Tracking each object within the group of objects using tracking history of the tracked object and the determined location of the tracked object within the group of objects.

18. The computer readable medium of claim 17, wherein the at least one feature comprises an integral image of the object.

19. The computer readable medium of claim 17, wherein the at least one feature comprises a color distribution of the object represented by a color histogram.

20. The computer readable medium of claim 17, wherein the at least one feature comprises a texture of the object.

21. The computer readable medium of claim 17, further comprising dynamically updating the at least one feature of the object.

22. A surveillance system comprising at least one camera operable to acquire an image of a group of objects and a processing unit operable to:
a. Generate an object model for each of a plurality of objects, wherein the generated object model comprises at least one feature of the object;
b. Scan each generated object model over the acquired image of a group of objects and compute conditional probability for each object model based on the at least one feature;
c. Select an object model with the maximum computed conditional probability and determine the location of the corresponding object within the group of objects;
d. Repeat steps c. and d. for at least one non-selected object model; and
e. Track each object within the group of objects using tracking history of the tracked object and the determined location of the tracked object within the group of objects.

23. The surveillance system of claim 22, wherein the at least one feature comprises an integral image of the object.

24. The surveillance system of claim 22, wherein the at least one feature comprises a color distribution of the object represented by a color histogram.

25. The surveillance system of claim 22, wherein the at least one feature comprises a texture of the object.

26. The surveillance system of claim 22, further comprising dynamically updating the at least one feature of the object.

27. The surveillance system of claim 22, wherein the object is a person.
